(19) United States
(12) Patent Application Publication
(10) Pub. No.: US 2014/0089492 A1
(43) Pub. Date: Mar. 27, 2014

(54) DATA COLLECTION AND CONTROL BY NETWORK DEVICES IN COMMUNICATION NETWORKS

(71) Applicants: Richard B. Nelson, Discovery Bay, CA (US); Anthony R. Rodrigues, Cupertino, CA (US)

(72) Inventors: Richard B. Nelson, Discovery Bay, CA (US); Anthony R. Rodrigues, Cupertino, CA (US)

(21) Appl. No.: 13/628,353

(22) Filed: Sep. 27, 2012

(51) Int. Cl. G06F 15/173

(52) U.S. Cl. 709/224

(57) ABSTRACT

Implementations provide network tasks in a communication network as performed by a network device. In some implementations, a method includes receiving instructions at a network device connected to the communication network, where the instructions define one or more conditions and define one or more associated network tasks to be performed upon occurrence of the one or more conditions. The one or more network tasks are related to activity on the communication network. The network device determines whether any of the one or more conditions have occurred. In response to any of the conditions occurring, the network device autonomously performs the one or more network tasks associated with the one or more occurring conditions as defined by the instructions.

### TECHNICAL FIELD

Implementations of the disclosure relate generally to communication networks and more specifically to data collection and control by network devices in communication networks.

### BACKGROUND

Communication networks are widely used to provide communication between different computer systems and electronic devices. Various network devices such as switches, routers, hubs, and other devices are connected in a network to manage the flow of data between various nodes of the network and other networks. Network systems of high complexity require monitoring of ports, data flows between nodes, and states of components, as well as control of network device functionality, to enable management of the network and troubleshooting and resolution of problems in the network. In some networks, system administrators collect data about the performance of various network components under normal and fault conditions and log collected data in a repository. The collected information is analyzed to correct problems or reconfigure system architecture to eliminate actual or possible faults and inefficiencies. However, such data collection, storage, and control, can require complex techniques that may be difficult to implement, debug, and maintain.

### SUMMARY

Implementations of the present disclosure relate to providing network tasks in a communication network as performed by a network device. In some implementations, a method for implementing network tasks on a communication network includes receiving instructions at a network device connected to the communication network, where the instructions define one or more conditions and define one or more associated network tasks to be performed upon occurrence of the conditions. The network tasks are related to activity on the communication network. The network device determines whether any of the conditions have occurred. In response to any of the conditions occurring, the network device autonomously performs the one or more network tasks associated with the one or more occurring conditions as defined by the instructions.

Various implementations and examples of the above method are described. For example, the network device can be a network switch, network hub, or a network router. The one or more network tasks can be performed based on executing commands provided in the instructions from a user. The network device can send data derived from the one or more performed network tasks over the network to a data repository storage device connected to the communication network. The one or more conditions can include one or more scheduled time conditions defined in the instructions such that the network device performs each of the network operations at scheduled times defined by the instructions. For example, the scheduled time conditions can include duration to execute the one or more network operations, the number of repetitions of performing the one or more network operations, and/or the frequency of performing the one or more network operations. The conditions can include the occurrence of a network event related to a change in connections on the communication network and/or data traffic on the communication network.

The one or more network tasks can be any of a variety of tasks. For example, the network tasks can include collecting data describing the network activity, where the network activity includes data traffic passing through one or more ports of the network device. The network tasks can include controlling one or more functions of the network device. In some examples, the network tasks can include enabling and disabling one or more ports of the network device to test operability of the one or more ports and/or to manage connections and disconnections of the network device according to a time schedule defined by the one or more conditions. The network tasks can include creating one or more test conditions received to test the operability one or more other network devices on the network, including creating a stimulus to the other network devices to force network path connectivity changes, trunk changes, and/or port state changes by the other network devices. The network tasks can include capturing device state information of the network device, such as processor utilization or memory utilization of the network device, current information stored in one or more network tables of the network device, and protocol state information. The network tasks can include globally enabling and disabling one or more features on the network device and on one or more other network devices connected to the communication network.

In some implementations, a computer program product includes a computer readable medium including program instructions to be implemented by a network device connected to a communication network, the program instructions for performing similar features as in the above method.

In some implementations, a network device includes a memory and at least one processor operative to access the memory and perform operations including receiving instructions at the network device, where the network device is connected to the communication network, the instructions defining one or more conditions and defining one or more associated network tasks to be performed upon occurrence of the one or more conditions. The one or more network tasks are related to activity on the communication network. The network device determines whether any of the conditions have occurred, and in response to any of the conditions occurring, the network device autonomously performs the one or more network tasks associated with the occurring conditions as defined by the instructions.

In various implementations and examples of the above system, the network device is a network switch, a network hub, or a network router. The one or more network tasks can include collecting data describing the network activity including data traffic passing through one or more ports of the network device. The one or more conditions can include scheduled time conditions defined in the instructions such that the network device performs each of the network operations at scheduled times defined by the instructions. The network device can send data derived from the one or more performed network tasks over the network to a data repository storage device connected to the communication network.

### BRIEF DESCRIPTION OF THE DRAWINGS

FIG. 1 is a block diagram depicting an example communication network which can be used with some implementations disclosed herein;

FIG. 2 is a flow diagram illustrating an example method of a network device receiving instructions from a user according to implementations disclosed herein;

FIG. 3 is a flow diagram illustrating an example method for enabling the performing of network tasks on a network device based on received instructions with reference to FIG. 2; and

FIG. 4 is a block diagram of an example network device which can be used in some implementations described herein.

### DETAILED DESCRIPTION

Various implementations described herein enable the performance of network tasks in a communication network by a network device. In some implementations, a network device such as a switch, router, or other device can autonomously check for conditions, and the network device can autonomously perform network tasks in response to the occurrence of such conditions. In some implementations, the network device can check for conditions such as the occurrence of a time provided in a time schedule, so as to perform network tasks according to an instructed schedule. For example, the network tasks can be performed for a specified time period, for a number of repetitions, and/or for a specified frequency. In some examples of network tasks, the network device can collect data based on monitoring data traffic through the network device and/or on connections of the network, control the enabling and disabling of ports on itself and/or indirectly the ports on other network devices of the network, obtain the device states of its own processor, memory, tables, or other components, test operability of itself and other devices, globally enable and disable features on the network, etc. The network device can store collected and logged data to a data repository accessible to system administrators or other users.

Described features allow a communication network to be monitored and controlled much more easily and efficiently than previous techniques. The data collection and control functions are embedded on the network devices of the network rather than being implemented using externally-hosted controllers, allowing routine scheduled monitoring of conditions, data collection and storage for managing the network and troubleshooting inefficiencies or problems, as well as control of network device functions for data collection, testing, and/or security features. Furthermore, the network device can perform such network tasks at any time without having to consider current network connection availability or compete with other data traffic on the network.

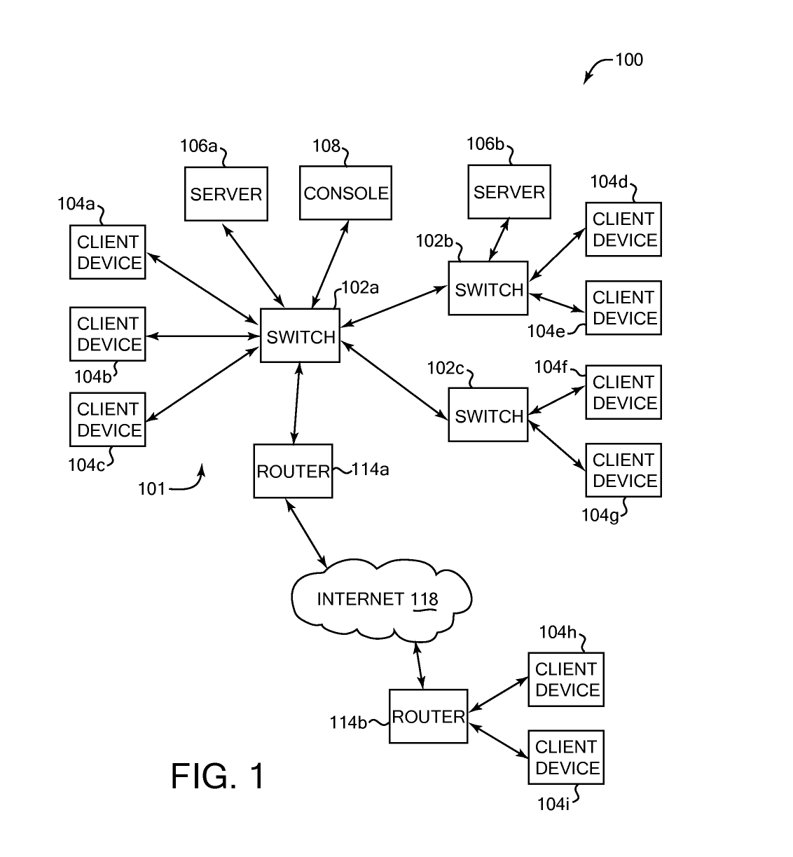

FIG. 1 is a block diagram of an example network system 100 which can be used with some implementations described herein. The network system 100 can include a network 101 providing communication links between multiple devices connected to the network. Network 101 can be any type of network that connects devices, such as a wide area network (WAN), local area network (LAN), wireless network, or others types of networks. Any of various networking standards can be used for network 101, such as Ethernet.

Switches 102 can be included in network system 100 to connect various other devices to each other and allow them to communicate via the network communication links. In the example of FIG. 1, client devices 104a, 104b, and 104c and server 106a are connected to switch 102a. Client devices 104d and 104e and server 106b are connected to switch 102b. Client devices 104f and 104g are connected to switch 102c.

Each switch 102 is a “network device,” which as referred to herein is a controller for the network that enables devices to communicate with each other over the network, and can include such devices as a switch, router, bridge, or hub. In some implementations, switches 102 can be managed switches, allowing commands to modify the operation of the switch. Furthermore, a single switch 102 as shown in FIG. 1 can represent one or more switches, such as a switch stack. A switch 102 includes a number of connections or ports, where each communicating device on the network can be connected to a port of the switch. Some implementations of a switch 102 allow multiple network devices to be connected to a single port of a switch 102. The switch manages the data communications between each device connected to it, such as sending data from one client device to a different client device or to a server that is the intended destination of the sender. In some implementations, a switch 102 can be connected to one or more other switches 102. For example, in FIG. 1, switch 102a is connected to switch 102b and to switch 102c. Multiple switches can be connected in the network system 100 to provide additional ports, locate ports in different physical areas, provide backup functionality, aid troubleshooting and testing, and/or provide other functions.

Each client device 104 and server device 106 can be any of a variety of types of devices. For example, in some implementations, client devices 104 and/or servers 106 can be implemented as desktop computers, laptop computers, tablet computers, portable devices, cell phones, media players, entertainment devices (television, disc player, stereo), mainframe computer, peripherals (printer, scanner, sensors), or other electronic devices.

Some implementations can use one or more of the servers 106 and/or client devices 104 as a repository for data and/or logs collected by the switches 102. For example, server 106a can provide storage for data collected by switch 102a, and server 106b can provide storage for data collected by switch 102b. Some implementations can provide dedicated storage associated with each switch 102. For example, a switch 102 may include internal storage, or may be connected to dedicated storage for the switch via a separate communication interface.

In some implementations, one or more switches 102 can be connected to another type of network device such as routers 114. In some examples, router 114a can interface the network 101 with one or more other networks. For example, the router 114a can be connected to a WAN such as the Internet 118, which is in turn connected to a network 116 via a router 114b. In one example, router 114b can be a wireless router including a switch network device, that is connected to client devices 104h and 104i. For example, router 114a can forward any data from client devices 104 or servers 106 on network 101 via the Internet 118 to router 114b and client devices 104h and/or 104i Likewise, router 114a can receive data intended for client devices 104 or server 106 on network 101 from the Internet 118, originating from network 116 or other source. Communication links of the networks that handle greatly increased traffic between network nodes, such as between different networks, can be considered trunk lines or trunk paths.

In some implementations, one or more of the switches 102 can be connected to a console 108. Console 108 can be any electronic device, such as a device similar to a client device 104, that allows a system administrator or other user to directly connect to the switch 102 to read status and other data from the switch 102 as well as provide instructions or commands to configure and control the operation of the switch 102. In some embodiments, the console 108 is connected to the switch via a serial port, Universal Serial Bus (USB) connection, or other type of interface that is not a connection of the network 101. Some implementations allow any of the client devices 104 to act as a console and provide console functions, using the network 101 as a connection to the intended switch 102.

Network devices such as switches 102 and/or routers 114 can be provided with functionality described herein to autonomously perform network tasks, as described in greater detail below. In some implementations, multiple such network devices of the network system 100 can be provided with this functionality and used to collect data and control functions at different nodes and connections of the network. In some implementations, different network devices can be instructed to perform different types of network tasks.

### Examples of Network Tasks for Network Devices

According to features described herein, a network device can autonomously perform network tasks. These tasks include actions or operations of the network device that relate to activity on the network. For example, such activity can be data sent and received at the ports of the network device, and/or the states of components of the network device that are associated with occurring network activity. The activity can be responses or activity of other devices connected to the network. In some implementations, network tasks can generally be of two types: data collection and control. For either data collection or control tasks, the network device can operate as an autonomous device according to features described herein.

Data collection (or data gathering) can be used in troubleshooting, testing, and general network monitoring uses. One example of a data collection network task is to have the network device monitor data traffic on the network and collect the results of the monitoring. Received instructions can, for example, instruct the router to count packets or other data units per time unit. In some implementations, the network device can monitor data passing through the ports of the network device and collect relevant statistical data about the data traffic. This can be performed directly by the network device itself with no need to use the network connections, thus providing more reliable monitored data due to no restrictions from other data traffic, as well as freeing up bandwidth on the network for other uses. In some implementations, a network device can determine and monitor data flowing through other ports or connections of the network. For example, some types of network devices can send out test data to particular ports or connections and determine when a response is returned, thus indicating bandwidth or other characteristics of ports on other network devices. A network device can store, or can be instructed to store, collected data to one or more particular data repository storage devices, such as a client device or server over the network or storage included in or directly accessible by the network device. In some examples, if no repository is specified, then a default repository storage device can be used.

Another example of a data collection task is capturing state information from the network device. This captured data can be sent to and stored in a data repository. The state information can be related to network activity. In some examples, the current CPU utilization of the network device can be monitored by the network device itself. Similarly, the current utilization of memory on the network device can be monitored by the network device. For example, the network device can determine how much memory is free, how much memory has been allocated, the size of blocks of memory, the extent of fragmentation in memory, etc. Furthermore, the state information can include port states (e.g., enabled or disabled), and interface up/down status. State information can also include current information stored in tables of the network device, which can be examined by the network device and values captured and stored. Such tables can include routing tables (e.g., in a router) holding values indicating routes to different network destinations. MAC address tables can also be examined, which hold MAC addresses indicating which devices are active on and connected to the network, and allowing the identity of the connected devices to be determined. The MAC addresses can also indicate where in the network the particular machines are connected. An Address Resolution Protocol (ARP) table can also be examined and its values captured, to find information linking MAC addresses to Internet Protocol (IP) addresses and to determine corresponding network activity. Protocol states handled by the network device can also be monitored and collected, e.g., transaction states for such protocols as Open Shortest Path First (OSPF), Routing Information Protocol (RIP), Virtual Router Redundancy Protocol (VRRP), Spanning Tree Protocols (STP), Link Layer Discovery Protocol (LLDP), Link Aggregation Control Protocol (LACP), Virtual LACP (VLACP), etc. Other device states including indicator light status or other readout status of the network device can also be captured. Overall, the data collection tasks can take snapshots of network device and network activity, including the tables described above, routing activity, port enable and data traffic statistics, and other information for historical analysis of network activity and network growth planning.

Another type of network task is a control network task. These tasks cause the network device to perform an action or utilize a function of the network device, which can be related to network activity. In some cases the controlled network device function may affect other components of the network. A control network task allows hardware control to a user without an external device or host having to send commands to the network device to perform the control functions.

One example of a control network task is enabling and disabling ports of the network device to enable or disable data communication via those ports. This can be performed for a variety of different functions and results. For example, ports can be enabled and disabled to perform testing of the network device, testing of other network devices, and/or testing of connections in the network. In one testing example, the network device can enable and disable one or more of its ports as a testing stimulus to test its own functionality and characterize its own behavior in response to the execution of network tasks.

In another testing example, a different, second network device can be tested by controlling one or more functions of the first network device. For example, the first network device can bounce port states by enabling and disabling one or more of its ports as a testing stimulus for the second network device. The enabling and disabling of ports can also force network path connectivity changes and/or trunk path changes for one or more other network devices, and/or force execution of port state changes (e.g., enables and disables) on one or more other network devices. The network device can also or alternatively be controlled to toggle protocol states in signals such as by sending, receiving, and acknowledgment states in protocols such as Open Shortest Path First (OSPF), Routing Information Protocol (RIP), Virtual Router Redundancy Protocol (VRRP), or other protocols to test the responses of the second switch. Repeated bouncing of port states or protocol states can be used to exercise network device behavior and test event recovery of both the instructed network device as well as other network devices.

In one example, multiple connections are used from a first switch to a second switch to test spanning tree reconvergence on the second switch. In a spanning tree reconvergence procedure, if a network connection changes or is disabled, the network controllers determine which network paths to use such that there are no redundant paths and looped paths in the network. In one scenario, ports are enabled and disabled in a testing procedure on the first switch to test the reactions of the second switch in the convergence procedure. For example, one port from the first switch is allowed to forward data traffic and the other ports are blocked or disabled. By executing a control network task to then disable the forwarding port, the transition on the second switch to another link into forwarding can be tested. Control network tasks can instruct or schedule the first switch to perform disables on a series of ports on itself, and during these disables, the blocked ports on the first switch are monitored to find state transitions to forwarding by the second switch. A subsequent set of network tasks to reenable the disabled ports can then test the transition back to the original forwarding and blocked states. These control network tasks can be repeated for a number of cycles, such that extensive testing is performed for the second switch. For example, the behavior of the second switch can be captured by a series of scheduled data collections of the spanning tree state, and this data can be uploaded to a repository such as a server for later analysis by a system administrator or other user.

Control network tasks can also be used to perform fault isolation on a network. For example, a control network task can disable ports of the switch to isolate particular portions of the network from other portions, allowing the isolated portion and/or non-isolated portion to be used and/or tested without the influence of the other portion.

Some implementations can use control network tasks to control connectivity of the network, such as for security purposes. For example, there may be connections into the network that have availability only during certain times. A scheduled network task can instruct one or more switches to control the access to those connections by enabling and disabling appropriate ports of the switches at appropriate times. In some implementations, a control network task can instruct one or more switches to disable particular ports while backups or other system activities are being performed on the network.

The network device can also be instructed in some implementations to enable or disable power output on its ports. For example, a network device can be instructed via control tasks to turn on or off the power provided on its ports to other specified devices connected to its ports, such as Power over Ethernet (PoE) devices that receive at least a portion of their operating power over the network connections. Some implementations can also use control tasks to change the priority of ports under particular conditions, such as which ports have priority to receive power when system power goes too low.

Control tasks can also be used to turn on or off the use of particular network communication protocols by the network device, and/or toggle or change protocol states, such as transaction states. Other features of the network device can be similarly turned on or off using control network tasks.

The data derived from network tasks such as data collection tasks and/or control tasks can be stored in a repository accessible to a system administrator or other user. For example, a user need only connect and download data from the repository to display desired network data at a console or management client device. For data collection tasks, the collected data describing the monitored network activity can be sent to the repository for storage. For control tasks, data indicating one or more results of the control tasks can be stored, such as indications of success or failure and/or related data.

The network tasks of the network device can be performed according to predetermined conditions that may have been instructed by a user. For example, such conditions can include time conditions, such as times to perform tasks as listed in a schedule. Other types of conditions may also be used to trigger particular network tasks. Some examples of conditions are described in greater detail below.

Scheduling of network tasks, for example, can allow periodic sampling of data traffic and device states across days, weeks, or months at specified time intervals with a number of samples being taken. Collected statistical data of network activity can be used for peak time study of traffic flows, monitoring of switch or stack memory usage and CPU utilization, or any other command-line interface available information such as routing table states and protocol states. For example, in a troubleshooting scenario, there may be a need to gather data and share that data with engineering for problem analysis. That data may need to be collected on a timed basis to see if there are particular times of day where network usage patterns change or otherwise contribute to the problem. By scheduling data collection at a timed interval, the switch becomes its own data collection platform without concern for the availability of resources at the physical site of the network. Scheduling can also be used to allow periodic control of network device functions. For example, the power on particular ports of the network device can be scheduled to be turned off at periodic times, such as on weekends.

### Example Implementations

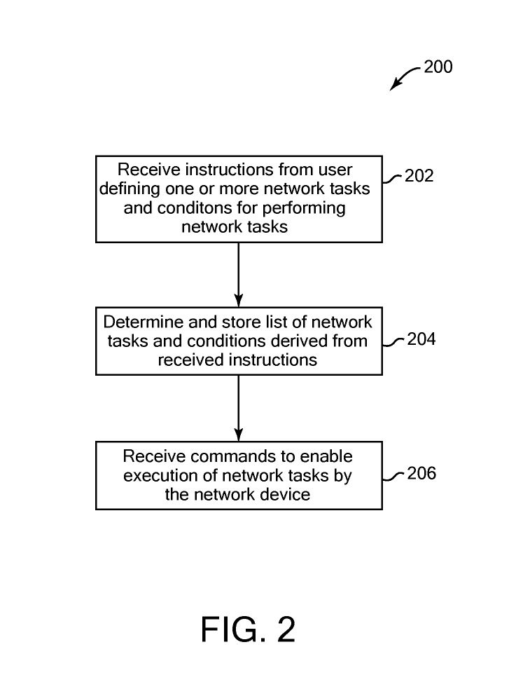

FIG. 2 is a flow diagram illustrating an example method 200 of network device receiving instructions from a user for implementing features described herein. For example, the method 200 can be implemented on one or more network devices of a network, such as a switch 102 or router 114 as shown in the example network system 100 of FIG. 1. Method 200 can be implemented by program instructions or code, which can be implemented by one or more processors of the network device such as microprocessors or other processing circuitry, and can be stored on a computer program product including a computer readable medium, such as a magnetic, optical, electromagnetic, or semiconductor storage medium, including semiconductor or solid state memory, a random access memory (RAM), a read-only memory (ROM), flash memory, a rigid magnetic disk, an optical disk, a solid-state memory drive, etc. Alternatively, method 200 can be implemented in hardware (logic gates, etc.), or in a combination of hardware and software.

In block 202, a network device receives instructions from a user, such as a system administrator, diagnostic tester, troubleshooter, or other user having access to the network. In some implementations, the instructions define one or more network tasks for the network device to perform. For example, the instructions can define each particular step or action in the network tasks. The network tasks can be actions or operations of the network device related to network activity. For example, as described above, the network tasks can include data collection network tasks and/or control network tasks.

Furthermore, the received instructions can include or designate conditions under which the defined network tasks are to be initiated and/or performed. In some implementations, each network task can have one or more associated conditions which must be met for the network task to be ready for execution by the network device. For example, one type of condition can be a time condition, such as a schedule indicating when and how the network tasks are to be performed. Some examples include a schedule indicating that a particular network task is to be performed at particular times and/or days, such as a particular time each day, only on particular days of the week, or a single upcoming date. Conditions can include parameters for executing the network task for a specified length of time or duration, for repeatedly executing the networking task according to a specified frequency (e.g., every week or every day), and/or for repeatedly executing the network task for a specified number of times.

Another type of condition for network tasks that can be used in some implementations is a trigger condition, such that one or more network tasks associated with the trigger condition are executed upon detection of the trigger condition. In some implementations, multiple trigger conditions can be assigned such that all such conditions must be met before associated network tasks are performed. In some examples, trigger conditions can be non-time-based conditions, such as a change in one or more connections on the network, a change in data traffic on the network, the occurrence of or change in one or more states of one or more network devices or other devices connected to the network, or other event. For example, trigger conditions can include a network connection becoming disabled by a fault in the network, another device sending a particular error signal or error message received by the network device, a predetermined data traffic threshold being reached or exceeded during monitoring of ports, memory or CPU usage rising above a predetermined threshold, or some other particular event. In some examples, the network device can be instructed to perform a network task to change its port configuration if a loss of a connection to another network device occurs; or the network device can be instructed to disable particular ports to power down particular connected devices if an emergency condition occurs.

In some implementations, the received instructions that define the network tasks can be provided in the form of commands, or such commands can be derived from the instructions. For example, command-line interface (CLI) commands can be provided by a user which include parameters for defining network tasks. In some examples, the commands can specify tasks and parameters for enabling and disabling of network device ports, the type of network task (e.g., data collection or control as described above), the time duration of a network task, the frequency of execution of a network task, the number of repetitions to execute the network task, the filename specification for the data file including data collected from network tasks (including a syntax for handling multiple versions of the same file, and the maximum number of files allowed), a command-line command that is provided as a parameter for execution, an alternate server address to which to save collected data, and a time reference source for a network task (e.g., a real time clock, Simple Network Time Protocol (SNTP), etc.). Some implementations of the network device can allow any CLI command of the network and network devices to be available for autonomous execution on the network device.

Furthermore, global commands and/or parameters can be included in the received instructions to control features over all the (compatible) network devices in the network. For example, global parameters can specify enabling and disabling a particular device feature across the entire network. Global parameters can specify a repository server address for every network device in the network as well as control values, such as for timeout and retry count for each network device (e.g., amount of time to wait before declaring a data transmission to the repository to have failed, and number of times retrying to save data to the repository).

In block 204, in some implementations, the network device determines and stores a list (e.g., a table) of network tasks and conditions derived from the received instructions. For example, this can be a list including relevant conditions which are examined by the network device, as well as the associated command(s) which are to be executed to implement the network task(s) if those conditions have been met. This list can be routinely consulted by the network device to determine the network tasks to perform during operation. In some implementations, other forms of providing instructions during network device operation can be used.

In block 206, the network device receives commands that enable execution of the received network tasks by the network device. Such commands can be received with the network task instructions of block 202, or at a different time. In some implementations, the network device can require that a user send one or more such enabling commands that enable the network device to execute the most recent instructions received in block 202, or in other implementations enable execution of any commands for network tasks. The network device can ignore any qualifying instructions until such an enablement command is received. Some implementations can use commands that provide selective enablement of a subset of received network tasks. In one example, enablement of network tasks can be instructed through the use of a global enablement parameter of a command for network task execution on the network devices of the network.

It should be noted that in the method 200, the order of blocks shown is not the only order in which these blocks can be performed, and the blocks can be performed in different orders and/or at least partially simultaneously where appropriate.

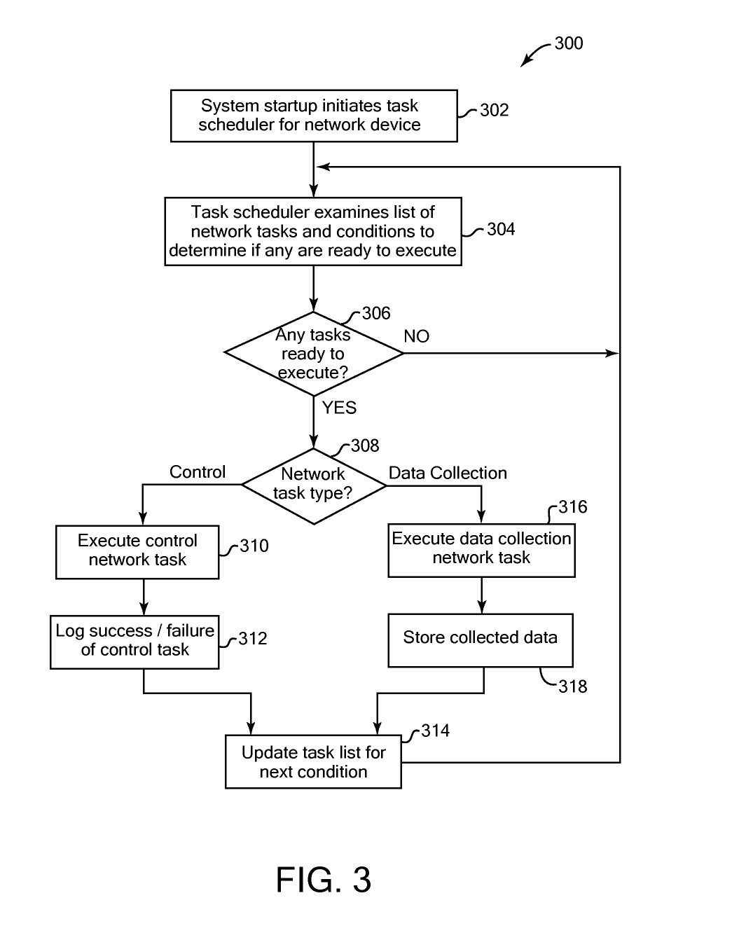

FIG. 3 is a flow diagram illustrating an example method 300 for enabling the performing of network tasks on a network device based on received instructions, such as the example instructions described above with reference to FIG. 2. For example, the method 300 can be implemented on one or more network devices in a network, such as one or more switches 102 or router 114 as shown in the example network system 100 of FIG. 1. Method 300 can be implemented by program instructions or code, which can be implemented by one or more processors of the network device such as microprocessors or other processing circuitry, and can be stored on a computer program product including a computer readable medium, such as a magnetic, optical, electromagnetic, or semiconductor storage medium, including semiconductor or solid state memory, a random access memory (RAM), a read-only memory (ROM), flash memory, a rigid magnetic disk, an optical disk, a solid-state memory drive, etc. Alternatively, method 300 can be implemented in hardware (logic gates, etc.), or in a combination of hardware and software.

In block 302, a system startup procedure can initiate a task scheduler of the network device in some implementations. For example, such a startup procedure can be implemented for all the network devices of a network at about the same time. The task scheduler can be a process running on the network device that examines conditions and network tasks as described below. In block 304, the task scheduler examines a list of instructed network tasks and/or conditions to determine if any network tasks are ready to execute. This list can be a list determined in block 204 of FIG. 2, for example. The task scheduler can examine the conditions provided in the list and determine whether any of the conditions have occurred. For example, for scheduled network tasks, the process can check the current time against time conditions in the list to determine whether the time conditions are met. For trigger conditions, the process can check the appropriate devices or network components to determine if the condition has occurred. Multiple network tasks may be simultaneously ready to execute in some embodiments. In one example, two network tasks may be ready to execute at the same time, where one task may cause data collection for one port of the network device, and the other task provides disabling control over a different port of the network device.

In block 306, the method checks whether there are any network tasks ready to execute, based on the conditions checked as described above with reference to block 304. In some implementations, the method can check both whether to start a particular network task, and/or whether to continue a previously-started network task. If no network tasks are ready for execution, then the method returns to block 304 to continue examining the list of conditions and network tasks. If the conditions of one or more tasks are met, then the method continues to block 308, in which the method checks the task type of each ready network task. In some implementations as described above, the types of network tasks can include data collection network tasks and control network tasks.

If a ready network task is a control task, then the method continues to block 310, in which the control network task is executed. For example, if the control task is specified by one or more CLI commands, those commands are executed. Some control tasks may have a particular instructed duration, such that it is executed for the specified duration. Alternatively, block 310 can execute an iteration of a network task, and the method can examine any ongoing duration for the task as a condition to be met each time it returns to check conditions in block 304. In block 312, the success or failure of the executed control task is logged. In some examples, the results of the control network task are stored as data in a log. For example, the network device can log whether an executed command was successfully executed or not. Some implementations can log additional or alternate data resulting from the task execution, such as data indicating data traffic changes through one or more ports after the control network task was performed, data indicating current states of the network device after the task was performed, etc. Such logs can be stored locally to the network device, or uploaded to a repository or other storage device over the network or other communication link. The method then continues to block 314, in which the task list is updated for the next condition of the present control task (if any). For example, if the executed control task is to be repeated over time or has a condition having a frequency, then after the current task is executed, the method can alter the condition entry to the next occurring time period in which the task should be executed. Some conditions may not need to be updated, such as conditions triggering a task based on a particular event that could occur at any time. The method then returns to block 304 to continue examining the list of network tasks and conditions. Blocks 310-314 can be executed for each control network task that is ready to be executed.

If in block 308 there is found to be a data collection network tasks ready to execute, then the method continues to block 316 to execute the data collection network task. In some implementations, the data collection task is specified by one or more CLI commands, and those commands are executed. Some data collection tasks may have a particular instructed duration, such that it is executed for the specified duration. Alternatively, block 316 can execute an iteration of a network task, and the method can examine any ongoing duration for the task as a condition to be met each time it returns to check conditions in block 304. In block 318, the method stores the collected data in an appropriate storage device. For example, in some implementations the network device can upload the collected data to a data repository, such a storage device on a server or client device. Some implementations can provide local storage for the network device, such as memory, hard disk, etc., or provide such a storage device connected directly to the network device over an interface such as a serial interface, Universal Serial Bus (USB), etc. In block 314, the task list is updated for the next condition of the present data collection task (if any). For example, as described above for some implementations, the next occurring time condition can be set in the list of conditions, if applicable. The method then returns to block 304 to continue examining the list of network tasks and conditions. Blocks 316, 318, and 314 can be executed for each data collection task that is ready to be executed.

It should be noted that in the method 300, the order of blocks shown is not the only order in which these blocks can be performed, and the blocks can be performed in different orders and/or at least partially simultaneously where appropriate. For example, the blocks 310, 312, and 314 can be processed in different orders or simultaneously/in parallel, and multiple ready tasks can be processed by these blocks at least partially simultaneously. In some implementations, the check for other ready tasks in block 306 can be continually performed while execution and processing of other network tasks is still being performed. Previously-started network tasks may also continue to be executing on the network device during performance of any of the blocks of method 300. Processing of control and data collection tasks can be simultaneous or at least partially simultaneous.

### Device Implementation Examples

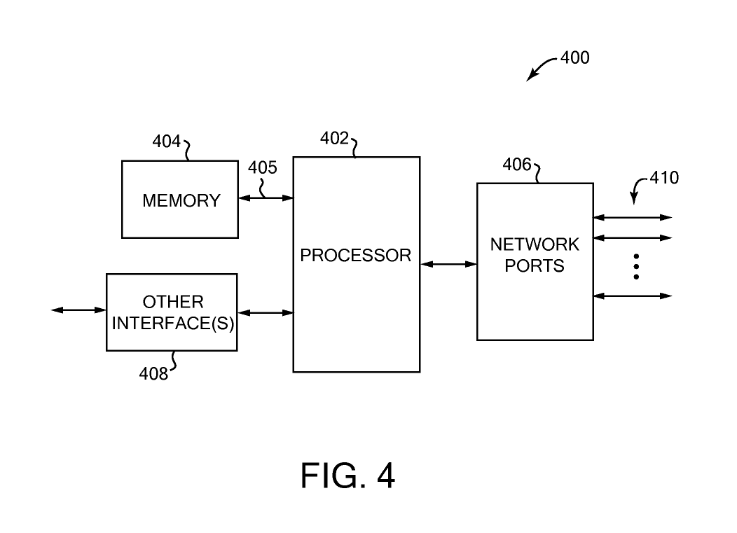

FIG. 4 is a block diagram of one example of a network device 400 which can be used with features described herein. Network device 400 can be, for example, a switch 102 as shown in the example of FIG. 1, or other type of network device such as router, bridge, hub, etc. Other electronic devices can be used as a network device. In a basic configuration, network device 400 typically includes one or more processors 402 and a system memory 404. A memory bus 405 can be used for communicating between processor 402 and system memory 404.

Depending on the desired configuration, processor 402 can be of any type of processing circuitry including but not limited to one or more microprocessors, microcontrollers, digital signal processors (DSPs), application specific integrated circuits (ASICs), or any combination thereof. In some examples, processor 402 can include one more levels of caching, a processor core, and registers. An example processor core can include an arithmetic logic unit (ALU), a floating point unit (FPU), a digital signal processing core (DSP), or any combination thereof. A memory controller can also be used with processor 402, or in some implementations memory controller can be an internal part of processor 402.

System memory 404 can store data used in the operation of the network device 400. For example, system memory 404 can include an operating system, one or more applications, and program data. In some implementations, the memory 404 can store software operative to perform network device functionality (such as for a switch, router, etc.) as well as read the instructions sent by a user to the device and perform other functions as described above, including reading and executing commands and parameters, implementing a task scheduler, and performing other blocks of method 400 using one or more processors. Alternatively, the software can be implemented as hardware or a combination of hardware and software. Memory 404 can be implemented as one or more of various types, volatile and/or non-volatile, including RAM, ROM, EEPROM, flash memory or other memory technology, etc.

Network ports 406 of the network device 400 are connected to other devices on the network using network links 410, and are used to route data to and from the network device between other devices on the network. Any number of ports can be provided in various embodiments, each controllable by the processor 402 using instructions provided in memory 406 or other storage.

Other interface(s) 408 can be provided in the network device 400 to allow data to be communicated between the network device and other devices using communication links other than the network ports 406. For example, the interface 408 can be a serial interface to connect to a console, which is a computer device able to receive status data from the network device and configure settings of the network device. Interfaces 408 can include other or additional interfaces in other implementations, such as USB. Any appropriate bus or interface controllers can also be included in the network device 400. For example, additional storage devices can be connected to the interface 408, such as CD-ROM, DVD, or other optical storage, magnetic cassettes, magnetic tape, magnetic disk storage or other magnetic storage devices, solid state memory storage, or any other medium which can be used to store the desired information and which can be accessed by network device 400. Any such computer storage media (including memory 406) can be part of or accessible by network device 400. Example computer storage media can include volatile and nonvolatile, removable and non-removable media implemented in any method or technology for storage of information, such as computer readable instructions, data structures, program modules, or other data.

Features described herein allow greatly increased efficiency in network tasks such as data collection and control compared to previous approaches. For example, previous approaches of data collection use an external host on which a system administrator configures and executes data collection capability, such as using Simple Network Management Protocol (SNMP) or telnet scripts. SNMP requires procuring and loading a special software tool and a set of Management Information Bases (MIBs) at the external host to obtain network device capabilities and characteristics, and then configuring the tool to collect the desired network data. This is a complex task due to the complexity of MIB data organization. Once such data is collected, it is difficult to decode the data since it is in the form of long strings of numbers such as object identifiers. If a network device does not have SNMP support implemented, collected data is not available using that method.

When performing telnet configuring in previous approaches, a software tool such as Expect is used which can use scripts to control a network device to collect the data of interest. Such tools must key on prompts and other specific character strings, has poor handling, is complicated to implement, and has to be custom tailored for each network device that is accessed. The tool also consumes a telnet session when running, thus taking up bandwidth and sessions from other data tasks on the network and failing to execute when such a session is unavailable. Data collected using such a tool includes other data such as logins and command entries, and so the data of interest must be extracted from much other extraneous data and decoded. There are some previous implementations of switch modules which implement commands allowing display of selected network data monitored by the modules. However, since this capability is implemented by specific command options, extending available options for the commands requires changes to the operating code of each switch.

In contrast, according to some features described herein, any CLI command is allowed to be available to be executed on a network device. This effectively places a hands-on user at the location of the network device by an automated capability on the network device. Since any command can be available, and since the network tasks can be implemented using the commands, any expansion of command line capability with subsequent releases is available to the network device to be used for automated data collection and control tasks. In addition, configuration parameters used by the network device allow the specification of a CLI command or a series of such commands to execute. As the command set expands, the capabilities of this feature expand accordingly.

Furthermore, described features allow a system administrator or other user to configure a set of command executions which collect data or perform control tasks, package the data for transmission, and upload the data to an accessible repository. The standard commands familiar to administrators can be provided to the network devices, and no external tools or complicated configuration is required. The data output by the network device is only the data requested, and no other data need be included in the output stored in the repository. In addition, the network tasks described herein require reduced network utilization. For example, there is no need for an external host to continually poll one or more network devices to read data and status. The initiation of execution of the network tasks is not in competition with other data traffic traveling through the network device or on the network, since such initiation of tasks are controlled autonomously on the network device and not in response to incoming data commands provided on network connections from an external host on the network. Due to the autonomous nature of the data collection and control functions of the network devices, there is less need for administrator presence at the physical site of the network to obtain statistical, troubleshooting or diagnostic data concerning network performance.

The illustrative implementations described in the detailed description, drawings, and claims are not meant to be limiting or restrictive. Other implementations may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein. The functional blocks, features, methods, devices, and systems described in the present disclosure may be integrated or divided into different combinations of systems, devices, and functional blocks as would be known to those skilled in the art.

What is claimed is:

1. A method for implementing network tasks on a communication network, the method comprising:
receiving instructions at a network device connected to the communication network, wherein the instructions define one or more conditions and define one or more associated network tasks to be performed upon occurrence of the one or more conditions, and wherein the one or more network tasks are related to activity on the communication network;
determining by the network device whether any of the one or more conditions have occurred; and
in response to any of the one or more conditions occurring, autonomously performing by the network device the one or more network tasks associated with the one or more occurring conditions as defined by the instructions.

2. The method of claim 1 wherein the network device is a network switch, network hub, or a network router.

3. The method of claim 1 wherein the one or more network tasks are performed based on executing commands provided in the instructions from a user.

4. The method of claim 1 wherein the one or more network tasks include collecting data describing the network activity, wherein the network activity includes data traffic passing through one or more ports of the network device.

5. The method of claim 1 further comprising the network device sending data derived from the one or more performed network tasks over the network to a data repository storage device connected to the communication network.

6. The method of claim 1 wherein the one or more network tasks include controlling one or more functions of the network device, the functions including enabling and disabling network ports of the network device, and toggling protocol states for signals provided by the network device.

7. The method of claim 1 wherein the one or more conditions include one or more scheduled time conditions defined in the instructions such that the network device performs each of the network operations at scheduled times defined by the instructions.

8. The method of claim 7 wherein the scheduled time conditions include at least one of: duration to execute the one or more network operations, the number of repetitions of performing the one or more network operations, and the frequency of performing the one or more network operations.

9. The method of claim 1 wherein the one or more conditions include the occurrence of a network event related to a change in at least one of:
one or more connections on the communication network, and data traffic on the communication network.

10. The method of claim 1 wherein the one or more network tasks include enabling and disabling one or more ports of the network device to test operability of the one or more ports.

11. The method of claim 1 wherein the one or more network tasks include enabling and disabling one or more ports of the network device to manage connections and disconnections of the network device according to a time schedule defined by the one or more conditions.

12. The method of claim 1 wherein the one or more network tasks include creating one or more test conditions received to test the operability one or more other network devices connected to the communication network, including creating a stimulus to the one or more other network devices to force at least one of network path connectivity changes, trunk changes, and port state changes by the one or more other network devices.

13. The method of claim 1 wherein the one or more network tasks include capturing device state information of the network device, the device state information including at least one of processor utilization of the network device, memory utilization of the network device, current information stored in one or more network tables of the network device, and protocol state information.

14. The method of claim 1 wherein the one or more network tasks include globally enabling and disabling one or more features on the network device and on one or more other network devices connected to the communication network.

15. A network device comprising:
a memory; and
at least one processor operative to access the memory and perform operations comprising:
receiving instructions at the network device, wherein the network device is connected to the communication network, wherein the instructions define one or more conditions and define one or more associated network tasks to be performed upon occurrence of the one or more conditions, and wherein the one or more network tasks are related to activity on the communication network;
determining by the network device whether any of the one or more conditions have occurred; and
in response to any of the one or more conditions occurring, autonomously performing by the network device the one or more network tasks associated with the one or more occurring conditions as defined by the instructions.

16. The method of claim 15 wherein the network device is a network switch, a network hub, or a network router.

17. The method of claim 15 wherein the one or more network tasks include collecting data describing the network activity, the network activity including data traffic passing through one or more ports of the network device.

18. The method of claim 15 further comprising the network device sending data derived from the one or more performed network tasks over the network to a data repository storage device connected to the communication network.

19. The method of claim 15 wherein the one or more conditions include one or more scheduled time conditions defined in the instructions such that the network device performs each of the network operations at scheduled times defined by the instructions.

20. A computer program product comprising a computer readable medium including program instructions to be implemented by a network device connected to a communication network, the program instructions for:
receiving instructions at the network device, wherein the instructions define one or more conditions and define one or more associated network tasks to be performed upon occurrence of the one or more conditions, and wherein the one or more network tasks are related to activity on the communication network;
determining by the network device whether any of the one or more conditions have occurred; and
in response to any of the conditions occurring, autonomously performing by the network device the one or more network tasks associated with the one or more occurring conditions as defined by the instructions.
